(19) United States
(12) Patent Application Publication
(10) Pub. No.: US 2019/0188583 A1
(43) Pub. Date: Jun. 20, 2019

(54) SYSTEM AND METHOD TO RECOMMEND MITIGATION ACTION USING CONVERSATIONAL AGENT

(71) Applicant: International Business Machines Corporation, Armonk, NY (US)

(72) Inventors: Ana Paula Appel, Sao Paulo (BR); Heloisa Caroline De Souza Pereira Candello, Hortolandia (BR); Ricardo Vieira Borges Franco, Sao Paulo (BR); Claudio Pinhanez, Sao Paulo (BR); Marisa Affonso Vasconcelos, Sao Paulo (BR)

(73) Assignee: International Business Machines Corporation

(21) Appl. No.: 15/849,439

(22) Filed: Dec. 20, 2017

(51) Int. Cl. G06N 5/04; G06F 17/30; G06N 3/00; G06N 99/00

(52) U.S. Cl. CPC G06N 5/04; G06N 99/005; G06N 3/006; G06F 17/30528

(57) ABSTRACT

A mitigation action recommendation method, system, and computer program product, includes building a cognitive machine learning model for a conversational agent, querying a user, via the conversational agent, to create a profile of the user by comparing answers from the user to the cognitive machine learning model to determine missing data, and creating a new query, based on the cognitive machine learning model, to acquire, via the conversational agent, at least some of the missing data from the user to update the profile.

### BACKGROUND

The present invention relates generally to a mitigation action recommendation method, and more particularly, but not by way of limitation, to a system, method, and computer program product, using an architecture of a conversational agent, for augmenting personal information records in a more friendly and personalized way and targeting to recommend mitigation actions to improve a user's situation or prevent a future unfavorable situation.

The quality of collected data can affect the ability to make accurate decision-making. A poor data quality may prevent companies from achieving their goals, make inaccurate predictions about performance, sales, marketing and can decrease user satisfaction. For example, in the financial sector, data collected by credit rating agencies are incomplete and most of time not up to date. Indeed, the agencies may have incorrect data (i.e., wrong address) on the user, or there may be gaps in the data. Thus, these agencies may not always have the big picture of the economic situation of a person, for example, why people are in a list of defaulters.

### SUMMARY

In an exemplary embodiment, the present invention can provide building a cognitive machine learning model for a conversational agent, querying a user, via the conversational agent, to create a profile of the user by comparing answers from the user to the cognitive machine learning model to determine missing data, and creating a new query, based on the cognitive machine learning model, to acquire, via the conversational agent, at least some of the missing data from the user to update the profile.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a mitigation action recommendation method 100;

FIG. 2 exemplarily shows a system 200 for mitigation action recommendation;

FIG. 3 depicts a cloud computing node 10 according to an embodiment of the present invention;

FIG. 4 depicts a cloud computing environment 50 according to an embodiment of the present invention; and

FIG. 5 depicts abstraction model layers according to an embodiment of the present invention.

### DETAILED DESCRIPTION

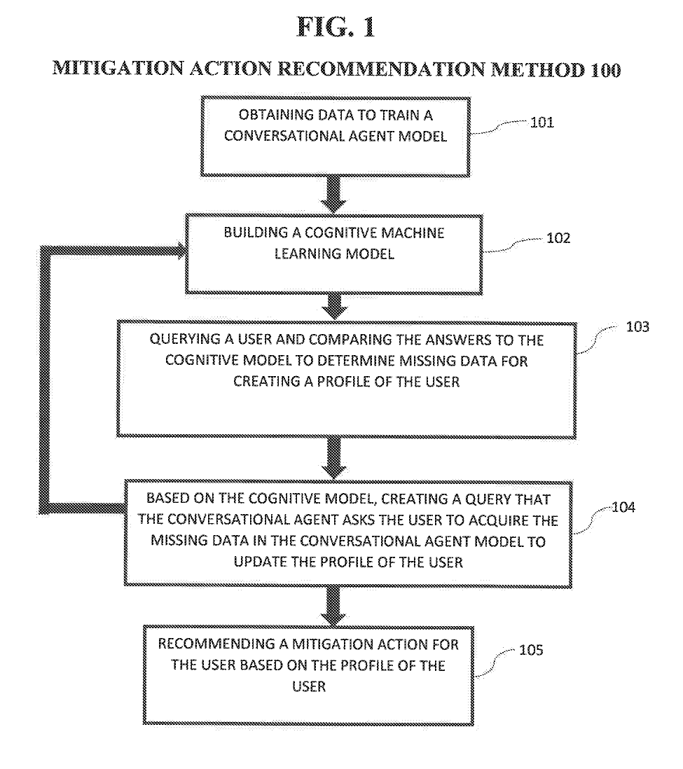

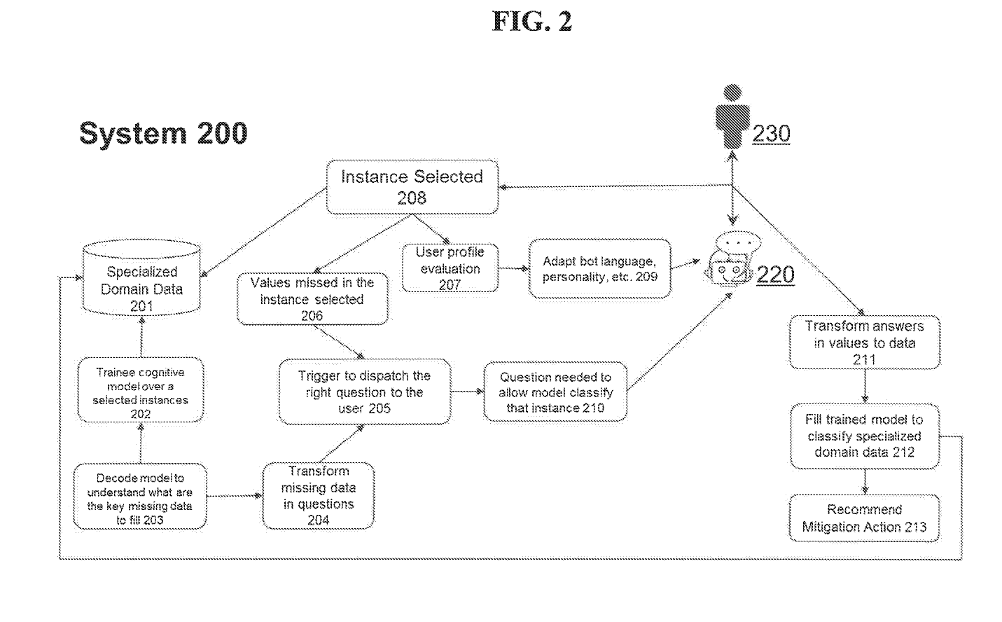

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity.

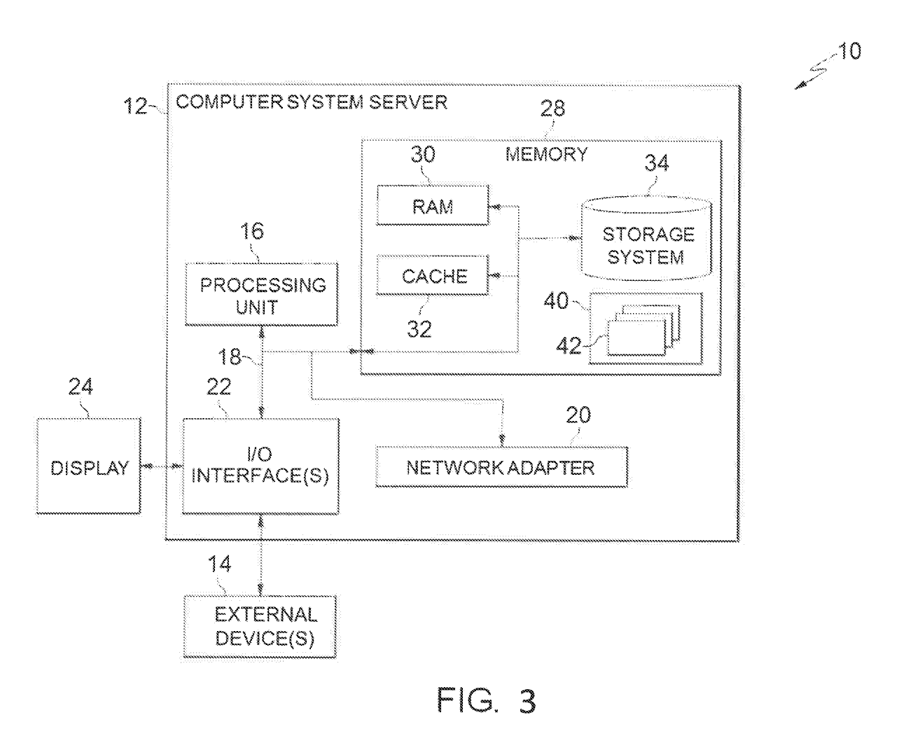

With reference now to the example depicted in FIG. 1, the mitigation action recommendation method 100 includes various steps for, using an architecture of a conversational agent (e.g., a chatbox, etc.), that can be used to augment personal information records in a more friendly and personalized way targeting to recommend mitigation actions to improve a user financial situation (e.g. credit score) or prevent future unfavorable financial situation (e.g. credit default). Personalized questions may mean the questions may be different for each user. For example, by interacting with the system, the user can provide additional information to recommend more personalized actions to improve or prevent his/her financial (e.g. credit score) situation (i.e., the conversational agent queries the user rather than the user querying the conversational agent). The conversational agent model utilized by the conversational agent can learn about the user current situation and can create cognitive personalized questions to acquire more information about the user targeting to recommend improving or preventing actions to better support the user decisions. Thus, for example, the chatbot asks the user questions. The chatbot also has the ability to learn how the user talks or writes in determining new questions with which to query the user. In one embodiment, a conversational agent can ask questions to a user, in a bad credit situation, and powered by a machine-learning model, the agent can infer characteristics of a user in order to ask questions that are more relevant and recommend actions to help the current financial situation of that user. As shown in at least FIG. 3, one or more computers of a computer system 12 according to an embodiment of the present invention can include a memory 28 having instructions stored in a storage system to perform the steps of FIG. 1.

Thus, the mitigation action recommendation method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

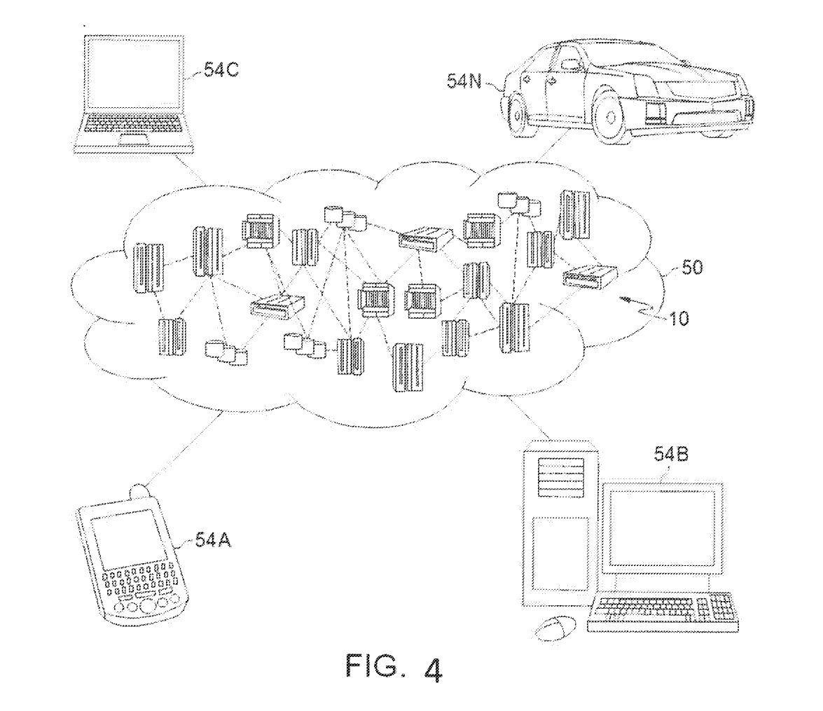

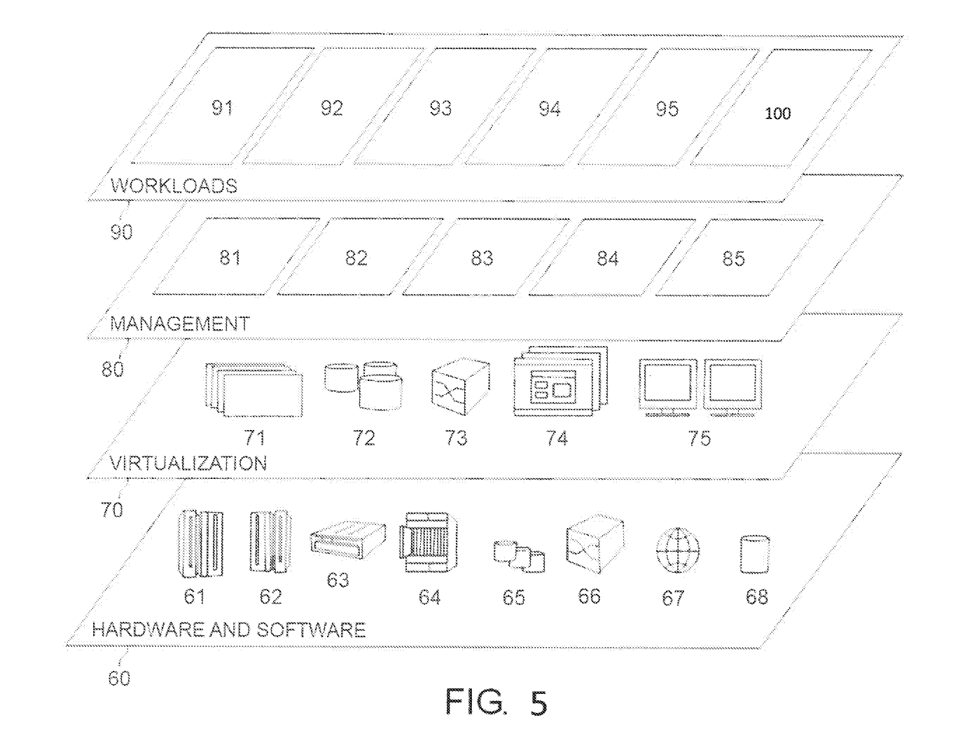

Although one or more embodiments (see e.g., FIGS. 4-5) may be implemented in a cloud environment 50 (see e.g., FIG. 5), it is nonetheless understood that the present invention can be implemented outside of the cloud environment.

In step 101 (or the specialized domain data 201), data is obtained to create a conversational agent training model for a conversational agent. For example, a logic tree of questions can be used to solicit relevant information about user in a domain (e.g., financial, medical, agriculture, etc.). The data can be obtained from, for example, call-center logs, Watson™ conversational services, chat box logs, etc. And, in step 102 (or in the training a cognitive model over a selected instance 202), a cognitive machine learning model is built based on the specialized domain data. The cognitive model includes various queries to ask a user to create a profile of the user according to the domain (e.g., financial, business, medical, etc.). For example, in the financial sector, the cognitive model can include queries such as an address, income, dependents, home-ownership, etc.

In step 103 (or as in the decoding the model to understand what are key missing data to fill 203), a user is queried and the answers by the users are compared to the cognitive model to determine missing data for creating a profile of the user. That is, the queries in step 103 are intended to create a profile of a user. However, with each user being unique, the queries may not be complete in the cognitive model and thus missing data is identified. For example, a user can be asked a series of questions but the profile returned does not match any in the cognitive model (e.g., the income, address, home-ownership, dependents, etc. indicate a first profile but the user's situation does not match the first profile). In the case that the user does not match a profile in the cognitive model, the missing information as to why the user does not match or what the user is doing to not match a profile is required to be obtained/learnt. For example, missing data can include a reason for why the user's credit cards are used in multiple-cities that do not match their residence but are not reported as fraud (i.e., their children or dependents are using the credit card in multiple cities and over spending).

Thus, in step 104 (or in the transforming the missing data into questions 204, triggering to dispatch the right question to the user 205, and the question needed to allow model to classify that instance 210), a query is created, based on the conversation model, that the conversational agent can ask the user to acquire the missing data in the conversational agent model to update the profile of the user. That is, there may be many variables in the state model which may not be filled. Interview techniques applied by ethnographers or design research practices can be applied to model the chatbot questions, to help people feeling more comfortable to talk about private matters and encourage the respondents to answer more honestly. Redundant questions may also be asked to confirm hat the user is telling the user. For example, questions that should have similar answers should be asked to determine if the user was truthful about a prior question.

That is, for the instance selected 208, the values missed in the instance selected 206 are identified, the user profile 207 being evaluated is corresponded to the missing values, and the conversational agent 220 is updated (i.e., the cognitive model).

Thus, in step 103, existing questions are asked to the user to create a profile for the user for the domain and missing data is identified. For example, if the user has a very low credit score, but all of the answers to the queries from the conversational agent return a variable that would result in a high credit score, the method can identify that there is missing data (i.e., a variable that is unaccounted for that results in the low credit score). Then, a new query is created to try to determine the missing data to update the profile of the user. The conversational model is updated with the new query (i.e., learning) such that the next time a user with a similar profile is using the method, the query will be asked. For example, the low credit score can be a result of the user traveling and not having internet access for a lengthy period of time. Thus, the new query will ask “have you recently travelled and were unable to pay your credit cards”. Therefore, the conversational agent can learn this question for the missing data and update the model accordingly.

In step 105 (or in the transforming the answers in values to data 211, filling the trained model to classify the specialized domain 212, and recommending mitigation action), a mitigation action is recommended for the user based on the profile of the user. For example, in the above financial embodiment where the user did not have internet access to pay credit card which resulted in a lower credit score, the recommendation can include setting up pre-payment to pay each month automatically. That is, the profile (and updated profile) are used to recommend an action to mitigate a negative aspect of the user profile. In another embodiment, in an agriculture domain, the recommendation can include “not watering crops this month because of heavy rainfall”. Thus, in step 105, recommendations can be provided with risk/benefits with a risk being, for example, obtaining access to curated data content and enough training adequate for the system and benefits being, for example, providing relevant and validated content in a more natural and simple language via a dialog/conversational interface

In one embodiment, a medial domain can be identified and the user is queried with questions by the conversational agent. The symptoms are known but the diagnosis is unknown but limited to a set of diagnosis (i.e., a set of diagnosis that include the symptoms). The conversational agent is unable to match the user profile (e.g., symptoms) with a particular diagnosis based on the current questions asked to the user without further information. Thus, the cognitive model is updated with new questions to attempt to determine the symptoms not identified. For example, the missing data can include the symptoms that would complete a profile to match with a particular diagnosis in the set. Thus, the conversational agent will create questions to ask the user to determine whether the user has (or does not have) a particular symptom. Based on the answers to the questions by the user, the conversational model is updated to initially ask the questions. Also, once the symptoms are determined to be a match for a diagnosis, a mitigation action is recommended (e.g., medication, treatment, etc.).

Therefore, the cognitive model can continuously be updated according to the user profile being incomplete (i.e., missing data) such that the initial set of questions to the user provide more accurate recommendations. Also, the deep learning can pinpoint issues with user's.

In one embodiment, the new query is created when the answers by the user to the initial set of questions create a profile with a delta from user information (i.e., known information about the user such as their credit score, medical conditions, etc.).

Although the embodiments herein were described in terms of a financial domain and medical domain, the invention is not limited thereto. For example, the domain can include a medical domain that directs searches targeted for health to a more curated content than a simple web search in a more natural and simple language accessible to all social layer of people, a social domain such as government providing natural language interface for conversation on different aspects of public services for hospitals, health assistance, education, tax, traffic, etc. or basic advice on home and health such as contamination, hygiene, first-aid, home plantation, baby care, accident prevention, electric energy, pluming, etc., an agribusiness domain to provide basic instructions on plantation, fertilization, pesticides, weather, harvesting and selling for different plants (similarly for animals management) in different regions, a financial advice domain to provide basic information about financial decision, as which is the best investment to apply money for a specific user, user should buy or not buy a house, or other things, a personal shopping adviser: based on historical personal spending and behavior as well as financial forecast of income/spendings, provide appropriate advices on natural language about buying decisions, etc.

Therefore, the invention can provide for a conversational agent that queries a user (rather than the user querying the conversational agent) to determine characteristics about the user to profile the user to provide a recommendation. That is, once the model is loaded with initial profile/attribute, the model can continuously learning from user's behavior and interactions in order to become better as time moves on (could also be scheduled to ingest external curated data form time to time to keep it up to date for specific topics).

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 3, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 4 are intended to be illustrative only and that computing nodes 10 and cloud computing environment 50 can communicate with any type of computerized circuit over any type of network and/or network addressable connection (e.g., using a web browser).

Referring now to FIG. 5, an exemplary set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the mitigation action recommendation method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented mitigation action recommendation method, the method comprising:
building a cognitive machine learning model for a conversational agent;
querying a user, via the conversational agent, to create a profile of the user by comparing answers from the user to the cognitive machine learning model to determine missing data; and
creating a new query, based on the cognitive machine learning model, to acquire, via the conversational agent, at least some of the missing data from the user to update the profile.

2. The computer-implemented method of claim 1, further comprising recommending a mitigation action for the user based on the profile.

3. The computer-implemented method of claim 1, wherein the missing data comprises a variable that results in the profile not matching an existing profile in the cognitive machine learning model.

4. The computer-implemented method of claim 1, wherein the missing data comprises data, that when combined with the answers from the user, causes the profile to be different than an expected profile of the user based on the answers from the user.

5. The computer-implemented method of claim 1, further comprising updating the cognitive machine learning model with the new query such that the querying asks the new query in the initial querying to profile the user.

6. The computer-implement method of claim 1, wherein the creating creates the new query when the answers by the user to the querying create a profile with a difference from user information.

7. The computer-implemented method of claim 1, embodied in a cloud-computing environment.

8. A computer program product for mitigation action recommendation, the computer program product comprising a computer-readable storage medium having program instructions embodied therewith, the program instructions executable by a computer to cause the computer to perform:
building a cognitive machine learning model for a conversational agent;
querying a user, via the conversational agent, to create a profile of the user by comparing answers from the user to the cognitive machine learning model to determine missing data; and
creating a new query, based on the cognitive machine learning model, to acquire, via the conversational agent, at least some of the missing data from the user to update the profile.

9. The computer program product of claim 8, further comprising recommending a mitigation action for the user based on the profile.

10. The computer program product of claim 8, wherein the missing data comprises a variable that results in the profile not matching an existing profile in the cognitive machine learning model.

11. The computer program product of claim 8, wherein the missing data comprises data, that when combined with the answers from the user, causes the profile to be different than an expected profile of the user based on the answers from the user.

12. The computer program product of claim 8, further comprising updating the cognitive machine learning model with the new query such that the querying asks the new query in the initial querying to profile the user.

13. The computer program product of claim 8, wherein the creating creates the new query when the answers by the user to the querying create a profile with a difference from user information.

14. A mitigation action recommendation system, said system comprising:
a processor; and
a memory, the memory storing instructions to cause the processor to perform:
building a cognitive machine learning model for a conversational agent;
querying a user, via the conversational agent, to create a profile of the user by comparing answers from the user to the cognitive machine learning model to determine missing data; and
creating a new query, based on the cognitive machine learning model, to acquire, via the conversational agent, at least some of the missing data from the user to update the profile.

15. The system of claim 14, further comprising recommending a mitigation action for the user based on the profile.

16. The system of claim 14, wherein the missing data comprises a variable that results in the profile not matching an existing profile in the cognitive machine learning model.

17. The system of claim 14, wherein the missing data comprises data, that when combined with the answers from the user, causes the profile to be different than an expected profile of the user based on the answers from the user.

18. The system of claim 14, further comprising updating the cognitive machine learning model with the new query such that the querying asks the new query in the initial querying to profile the user.

19. The system of claim 14, wherein the creating creates the new query when the answers by the user to the querying create a profile with a difference from user information.

20. The system of claim 14, embodied in a cloud-computing environment.
